(19) United States
(12) Patent Application Publication
(10) Pub. No.: US 2006/0144748 A1
(43) Pub. Date: Jul. 6, 2006

(54) Pill organizer and dispenser

(76) Inventor: Richard E. Slaughter, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 11/268,257

(22) Filed: Nov. 7, 2005

Related U.S. Application Data
(60) Provisional application No. 60/640,792, filed on Dec. 30, 2004.

(51) Int. Cl. G07F 11/10

(52) U.S. Cl. 206/538; 221/133

(57) ABSTRACT

A pill organizer and dispenser enables a supply of medicinal pills to be taken over a pre-selected period of time by placement on a grid which has slots representing days of the week for containment of pills in respective receptacles which may then be dispensed by tilting the grid to cause the pills to slide between the slots for collection.

### RELATED APPLICATION

This application is a regular utility of U.S. Provisional Patent Application Ser. No. 60/640,792, filed on Dec. 30, 2004. The entire disclosures of this application is incorporated herein by reference.

### FIELD OF THE INVENTION

The present invention relates to a device for organizing pills and vitamins in a dispenser for holding the pills for daily dispensing.

### BACKGROUND OF THE INVENTION

It has become common place for a person to be required to ingest medicinal pills on a daily basis and, in many instances, for the rest of that person's life. One must be concerned with the possibility that too much or too little of the prescription or vitamin may be injurious to one's health. Furthermore, when even as many as 10 pills, or more, may be needed for disease prevention and control, it is critical that these pills be taken on time and not to be forgotten. Keeping track of medications has become quite a chore which is confronted by millions. Accordingly, it would be advantageous to provide a pill collector and dispenser which would serve to satisfy current demands.

### SUMMARY OF THE INVENTION

This invention is directed to a pill collector and dispenser of relatively simple construction, yet will serve to satisfy current demands.

The pill collector and dispenser comprises a grid having a base for holding the pills. A plurality of ridges are fixed to the base and extend from one side of the base to an opposite side thereby forming slots which represent the days of the week. The base also has bosses between the ridges which extend substantially perpendicular to the ridges from side-to-side of the base thereby forming a receptacle for the pills which are held on the base. Each of the ridges has an upper edge extending above the height of the bosses. A lid engages the upper edges of the ridges to contain the pills in receptacles formed by the lid, ridges and bosses. This arrangement allows for filling and collating pills that must be taken daily by loading them into the appropriate receptacles for dispensing medication or vitamins as needed. The grid is compartmentalized with dispensing instructions to aid in the placement of pills into receptacles for dispensing.

### BRIEF DESCRIPTION OF THE DRAWINGS AND PREFERRED MODE OF THE INVENTION

The advantages and features of the pill collector and dispenser of this invention will be better understood with reference to the following detailed description and accompanying drawing in which

FIG. 1 is a top perspective view of a portion of the grid according to the preferred embodiment of the present invention.

FIG. 2 is a side view of an end of the grid of FIG. 1 showing the relationship of the bosses to a ridge.

FIG. 3 is a perspective view of a medication listing which may be seen through the base of FIG. 1 when the base is made of a transparent plastic.

FIG. 4 is a perspective view of a box, preferably made of clear plastic, for receiving the grid of FIG. 1 with the underlying medication instructions of FIG. 2.

FIG. 5 is a side view of a sliding panel which is operable to engage the slots formed in the grid and box for discharging pills from each of the daily slots by moving the panel outwardly thereby permitting the pills in each of the daily slots to either be accumulated at one side or the bottom of the box for daily dispensing or discharged in its entirety into a separate daily container depending on whether the sliding panel clears the open end of the slot for a given day or is pulled fully open. The sliding panel may be removed entirely if the consumer decides to always dump the pills into a separate daily container.

### DETAILED DESCRIPTION OF THE PREFERRED EMBODIMENT

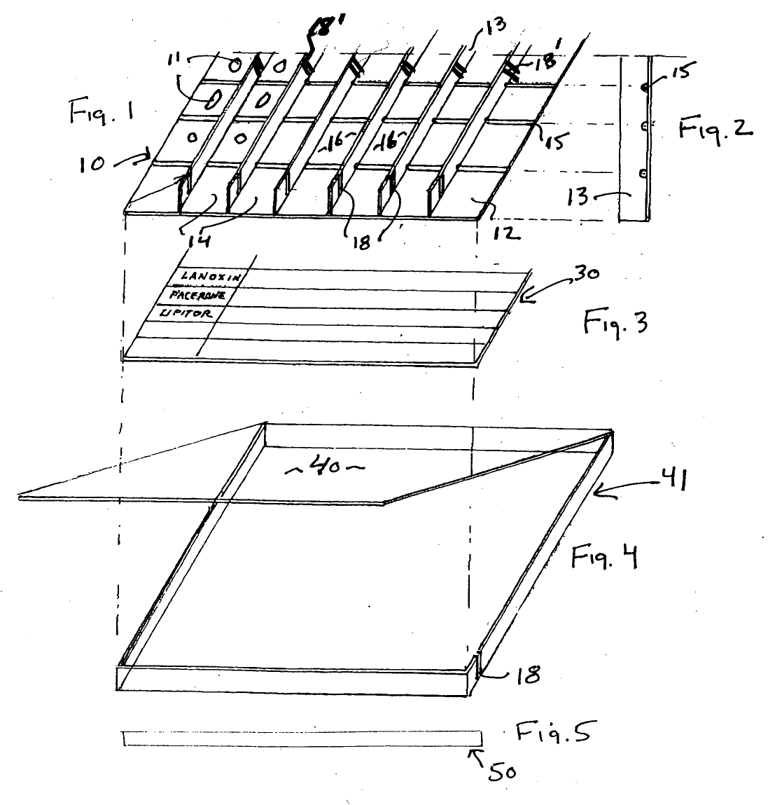

Referring to FIG. 1, a plastic grid 10 is shown for holding in a preselected and organized fashion a supply of pills 11. The grid essentially consists of a base 12 having a plurality of ridges 13 fixed to the base and extending from one side of the base to an opposite side, thereby forming daily dispensing slots 14. For example, seven (7) slots are shown which represent Monday to Sunday. Each slot 14 represents the day's worth of medicinal pills depending upon the number of pills to be taken. There are bosses 15 between the ridges that extend substantially perpendicular to ridges from another side of the base to its opposite side thereby forming a receptacle 16 for each of the pills 11 placed on the grid base 12. Each of the ridges 13 has an upper edge extending above the height of the bosses (best shown in FIG. 2) for engaging the lid 40 or panel of a box 41 (FIG. 4) which is preferably used to contain the pills held by the grid.

In its broadest form, the bosses 15 may be eliminated and the receptacle 16 can be defined by the surface of the grid between ridges 13 so that the pills may be placed on the surface. For example, a listing of medications 30 may include the grid drawn on the sheet that lists the medications for organizing the pills for dispensing. In this form of the invention, the pills are not really contained by bosses 15 and the ridges 13, however, the pills may be organized in holding areas on the grid between slots 18 formed by the ridges 13 for dispensing by tilting the grid so that the pills may slide out of the slots 14. In addition, in another form of the invention, not shown, the ridges 13 could be formed to extend beyond the grid base 12 so that they can be inserted part way into the hand or daily existing organizer so that the pills may be dispensed without mixing into an adjacent daily box.

With reference to FIGS. 1-5, in its most preferred form, the box 41 in FIG. 4 is formed of clear plastic for receiving a sheet 30 having a descriptive listing of medication. For example, a sheet of paper setting forth the medications as shown in FIG. 3 may be used. The listing of medications is placed in the box 41 of FIG. 4 and is superimposed by a transparent plastic grid of FIG. 1. The transparent, removable plastic grid of FIG. 1 enables the list of medications to be removed and customized or replaced as needed and to be seen through the grid base 12 as the pills are placed in the receptacles 16 formed by the ridges 13 and bosses 15, and contained by the lid 40 of the box 41 when the lid is closed.

The pill collector and dispenser of FIGS. 1-5 works by placing pills 11 in the respective receptacles 16 between the ridges 13 and the bosses 15, taking care to align them according to the medication instructions of FIG. 3 which underlie the transparent face of the grid 10. After the pills 11 are loaded onto the grid 10 according to the listing of medications which underlie the transparent base, and the grid 10 is held in the box 41, the lid 40 of the box may be closed to contain the pills in their respective receptacles 16. A sliding panel or plurality of panels 50 of the type shown in FIG. 5 operates in each slot 18 and 18′ to selectively open a side or bottom of the grid 10 for dispensing pills 11 which have been held in the respective daily (or daily section) receptacles 16 between the ridges 13 of the grid 10. The space between slots 18 and 18′ provides a daily dispensing time section corresponding to morning, noon, dinner, night, etc., for dispensing pills as needed during the day.

When the sliding panel 50 or plurality of panels 50 are closed, the pills 11 may then be collected into the bottom of each section (morning, noon, dinner, night, etc.) in each daily slot so they may be taken by the consumer as needed by removing them or sliding open the appropriate panel 50 to clear the slot for that day or time of the day.

Dispensing is accomplished by tilting the box 41 so that the pills 11 slide down over the bosses 15 and into one side of the box 41. The pills 11 may also be dispensed by turning the box 41 upside down and tilting it so that the pills 11 more readily fall over the bosses 15 but remain in the daily slots. Each sliding panel 50 is closed by sliding it through each slot 18 or 18′, as the case may be, to form a barrier for collection of pills 11. The pills 11 may then be collected in each daily slot or daily section so they may be taken by the consumer as needed, for example, by sliding open one or more panels 50 to clear the slot for that day or daily section. The sliding panel 50 or panels 50 are simply moved further as needed to clear each day or daily section for dispensing in a similar manner. Alternatively, all the pills 11 may be slid all at once through the open ends of the daily slots into a separate daily container by sliding all panels 50 in slots 18 and 18′ all the way open or removing pills 11 entirely if desired.

The foregoing description illustrates the operation of the preferred embodiment of the pill organizer and dispenser, but is not meant to limit the scope of the invention.

What is claimed is:

1. A pill collector and dispenser for organizing a supply of medicinal pills to be taken over a pre-selected period of time comprising
a grid having a base and a plurality of ridges fixed to the base extending from one side of the base to an opposite side and forming slots which represent days of the week,
holding areas on the base surface between said ridges extend substantially perpendicular to the ridges from one side of the base to another side, said holding areas forming with said ridges receptacles for holding in an organized fashion the preselected supply of pills,
said pills are dispensed from said grid upon tilting the grid to cause the pills to slide between the ridges for collection on one side of the grid.

2. The device of claim 1 wherein said holding areas on the base surface comprise bosses between said ridges extending substantially perpendicular to the ridges thereby forming with said ridges receptacles for holding said pills,
said ridges having an upper edge extending above the heights of the bosses enabling said pills to be contained therebetween, and
a panel engaging the upper edges of said ridges to contain the pills in their respective receptacles.

3. The device of claim 1 having a pill stopper slidable between said ridges to selectively open the slots on a daily basis to collect the pills for dispensing of pills daily or slidable to fully open the slots for dispensing pills all at once into a separate daily container.

4. The device of claim 1, 2 or 3, wherein said grid is made of transparent plastic and is contained in a transparent plastic box, a sheet displaying medicinal instructions for the preselected supply of pills is disposed in the box underlying said transparent grid such that the instructions for collecting and dispensing the pills are visible through the plastic grid.

5. The device of claim 4 wherein said box has a hinged lid which forms said panel.

6. The device of claim 1 having a plurality of pill stoppers slidable between said ridges to selectively open the slots to collect the pills for dispensing.

7. The device of claim 6 wherein said pill stoppers are arranged for dispensing daily or during the day.
